(19) United States
(12) Patent Application Publication
(10) Pub. No.: US 2002/0175318 A1
(43) Pub. Date: Nov. 28, 2002

(54) Optical recording material and optical recording medium using same

(76) Inventors: Byung-Ki Cheong, Seoul (KR); Soon Gwang Kim, Goyang-si (KR); Won Mok Kim, Seoul (KR); Taek Sung Lee, Seoul (KR); Sung Jin Park, Seoul (KR); Tae-Yon Lee, Seoul (KR); Ki-Bum Kim, Seongnam-si (KR)

Correspondence Address: David A. Einhorn, Esq., Anderson Kill & Olick, P.C., 1251 Avenue of the Americas, New York, NY, 10020, US

(21) Appl. No.: 10/112,510

(22) Filed: Mar. 29, 2002

(30) Foreign Application Priority Data
Mar. 29, 2001 (KR) 2001-16425

(51) Int. Cl. G02B 5/20

(52) U.S. Cl. 252/584

(57) ABSTRACT

Disclosed in this invention is an optical recording material having high speed crystallization and excellent erasability, which comprises a composition having the formula of:

(AₐB_{b}C_{c})ₓ(GeₐSb_{b}Te_{c})₁₋ₓ

wherein, A is an element selected from the elements belonging to the IV group in the periodic table; B is an element selected from the elements belonging to the V group in the periodic table; C is an element selected from the elements belonging to the VI group in the periodic table; a, b and c are atomic ratios; x is a fraction in the range of 0 to 1; and the elemental binding energy of at least one of A, B and C is lower than that of the corresponding element in the GeSbTe part.

### FIELD OF THE INVENTION

The present invention relates to an optical recording material, and more particularly to an optical recording material applicable to the recording layer of a phase-change type optical recording medium, which comprises a solid solution of a GeSbTe alloy and a ternary alloy having the same crystalline structure as the GeSbTe alloy.

### BACKGROUND OF THE INVENTION

With the advent of CD-ROMs, there have been increasing demands for rewritable recording media that can effectively accommodate multi-media related software such as video images, still images and animations. As a result, there have been developed CD-RWs(compact disks-rewritable) which can be recorded and erased repeatedly. The CD-RWs include magneto optical type disks, phase-change type optical disks, and the like. A phase-change type optical disk makes use of a recording material which is capable of undergoing a phase change between crystalline and amorphous phases in response to light, e.g., a laser beam, and this type of optical disk is compatible with the information reading mechanism used in conjunction with conventional CDs.

In a phase-change type medium, information can be recorded on or erased off a recording layer by way of interconverting the phase of the recording pits between crystalline and amorphous phases with controlled laser beam irradiation. The tracks in the recording layer contain recorded signals formed thereon when a laser beam is irradiated so as to convert the phase of a specific area of the recording layer from crystalline to amorphous state, or vise versa.

Therefore, the recording material for a phase-change type optical medium is required to possess following properties: the difference in reflectivity between its amorphous and crystalline states corresponding the recorded and erased states of information, should be large; its melting temperature should not be too high or too low; it can easily form an amorphous state by cooling from its liquid state; the amorphous state should be stable under the reproducing and use conditions; and the crystallization speed should be sufficiently high so that the recorded data can be erased within the restricted beam dwell time.

A primary problem associated with a high-performance recording medium is how to satisfy the requirements imposed by increasing the recording density and transforming speed. The recording density may be increased by reducing the size and interval of recording marks and this can be accomplished by reducing the laser beam spot size by way of using shorter wavelength laser and an objective lens having a high numerical aperture (NA). The transforming speed can be improved by increasing the linear velocity besides the improvement brought about by increased recording density.

However, the beam dwell time becomes shorter with smaller laser beam spot size and higher liner velocity. FIG. 1 shows the relationship between the linear velocity and the beam dwell time at two different laser beam wavelengths and objective lens NAs, wherein the beam dwell time is represented by FWHM (full width half maximum) spot diameter/linear velocity (0.57λ/vNA, λ is wavelength of laser (nm), v is linear velocity of disc (m/s), and NA is numerical aperture of objective lens). As is shown in FIG. 1, the beam dwell time for a 22 GB single layer format with λ=405 nm and NA=0.85 becomes shorter by about 50% and 75% when the data transforming speed is increased by two fold (represented by “4×”) and four fold (represented by “8×”), respectively, as compared with the transforming speed (represented by “2×”) of a 4.7 GB single layer format with λ=650 nm, NA=0.6 and v=8.1 m/s [timing window (Tw)=17.1 ns].

Such decrease in the beam dwell time causes, e.g., incomplete crystallization of amorphous recording marks during erasing, making it impossible to overwrite. Therefore, among the properties required of a phase-change type optical recording material, high crystallization speed is most critical.

Tellurium (Te)-based materials, especially, GeSbTe alloys, have been utilized as a phase-change type recording material for data storage. In order to improve the crystallization speed of GeSbTe alloys, various efforts have been made to date. For example, U.S. Pat. Nos. 5,100,700, 5,196,294, 5,278,011 and 5,753,413 disclose GeSbTe alloys incorporated by a third element such as O, Bi, Sn, Se, In, etc. Further, U.S. Pat. No. 5,965,229 and Korean Laid-open Patent Publication Nos. 97-67128 and 98-11179 disclose a recording medium comprising a crystallization-accelerating SiN, SiC or GeN layer disposed between dielectric and recording layers. None of these recording media, however, have shown a sufficient level of crystallization speed, and thus, have failed to solve the problem of incomplete erasing under a high linear velocity condition.

### SUMMARY OF THE INVENTION

Accordingly, it is a primary object of the present invention to provide an optical recording material for a phase-change optical recording medium having high-speed crystallization and excellent erasing properties.

The above objects of the present invention can be satisfied by an optical recording material comprising a composition having the formula of:

(AₐB_{b}C_{c})ₓ(GeₐSb_{b}Te_{c})₁₋ₓ

wherein A is an element selected from the elements belonging to the IV group in the periodic table; B is an element selected from the elements belonging to the V group in the periodic table; C is an element selected from the elements belonging to the VI group in the periodic table; a, b and c are atomic ratios; x is a fraction in the range of 0 to 1; and the elemental binding energy of at least one of A, B and C is lower than that of the corresponding element in the GeSbTe part.

### BRIEF DESCRIPTION OF THE DRAWINGS

The above and other objects and features of the present invention will become apparent from the following description thereof, when taken in conjunction with the accompanying drawings wherein:

FIG. 1 shows the relationship between linear velocity and beam dwell time;

FIG. 2 represents X-ray diffraction patterns of the thin layers prepared in Comparative Example 1 and Example 1 before and after thermal treatment;

FIGS. 3 and 4 respectively depict the changes in reflectivity with radial distance of the discs prepared in Comparative Example 2 and Example 2;

FIG. 5 presents the relationship between recording power and carrier to noise ratio (CNR) of the optical recording discs prepared in Comparative Example 2 and Example 2;

FIG. 6 shows the relationship between maximum DC erasability and linear velocity of the optical recording discs prepared in Comparative Example 2 and Example 2.

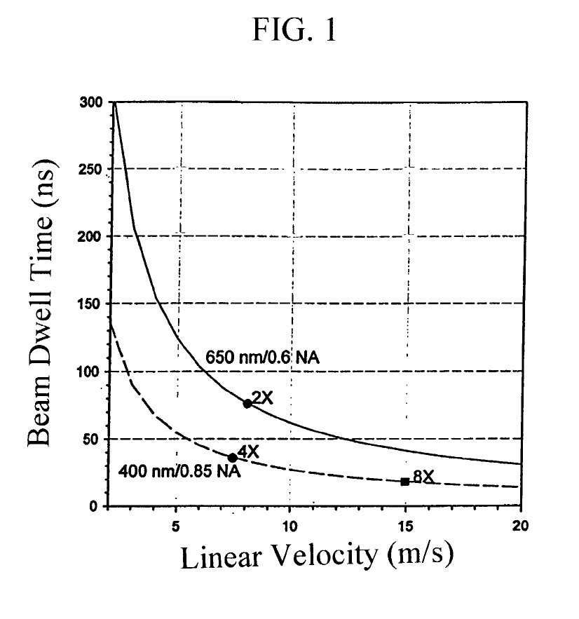

### DETAILED DESCRIPTION OF THE INVENTION

Optical recording materials according to the present invention comprise a ternary alloy (i.e., ABC alloy) which forms a pseudo-binary solid solution with a GeSbTe alloy.

Specifically, the optical recording materials of the present invention comprises a composition having the following formula:

(AₐB_{b}C_{c})ₓ(GeₐSb_{b}Te_{c})₁₋ₓ

wherein, A is an element selected from the elements belonging to the IV group in the periodic table; B is an element selected from the elements belonging to the V group in the periodic table; C is an element selected from the elements belonging to the VI group in the periodic table; a, b and c are atomic ratios; x is a fraction in the range of 0 to 1; and the elemental binding energy (the bond energy in the elemental state) of at least one element of A, B and C is lower than that of the corresponding element in the GeSbTe part.

In one embodiment, the GeSbTe alloy may be a stoichiometric alloy of Ge, Sb and Te, preferably selected from the group of Ge₄Sb₁Te₅, Ge₂Sb₂Te₅, Ge₁Sb₂Te₄ and Ge₁Sb₄Te₇. Therefore, it is preferable that (a, b, c) is selected from the group consisting of (4, 1, 5), (2, 2, 5), (1, 2, 4) and (1, 4, 7).

In one embodiment, the ABC alloy is a chalcogenide which is stoichiometrically equivalent with the GeSbTe alloy.

The crystallization speed of a stoichiometric GeSbTe alloy is high because crystallization can be easily accomplished by short-distance diffusion of atoms to exchange lattice positions. Therefore, it is preferable that the ABC alloy has the same stoichiometric composition as the GeSbTe alloy so that a solid solution of the ABC and GeSbTe alloys can be uniformly crystallized.

In addition, A, B and C are elements belonging to the IV, V and VI groups in the periodic table, respectively, and the elemental binding energy of at least one of A, B and C is lower than that of the corresponding element of the GeSbTe portion. According to the report on GeTe alloys by Y. Maeda and M. Wakagi [Jpn. J. Appl. Phys., 30, 101(1991)], as the amorphous GeTe crystallizes, the Ge—Te bond length increases and the Ge—Ge bond disappears. Further, J. H. Coombs, et al. [J. Appl. Phys., 78, 4918(1995)] studied crystallization speed of GeSbTe alloys in which a part of Ge is replaced with Sn, or a part of Te is replaced with S or Se. According to these studies, the nucleation speed increases when a part of Ge is replaced with Sn whose binary binding energy is lower than that of Ge, while the nucleation speed decreases when a part of Te is replaced with S or Se whose binary binding energy is higher than that of Te. These studies show that the elemental binding energy is closely related to the crystallization speed. Therefore, in order to increase the crystallization speed, it is preferred that at least one of A, B and C has a lower elemental binding energy than that of a corresponding element in the GeSbTe alloy. Thus, A is preferably Sn or Pb, and B is preferably Bi.

Further, it is preferable that the crystal structures of ABC alloy and GeSbTe alloy are about the same. When the crystal structures are the same and the difference between their lattice constants is not big, a substitutional solid solution of a single phase can be formed according to the Hume-Rothery rules.

The preferable ABC alloys of GeSbTe are as follows:

Ge₄Sb₁Te₅:Pb₄Bi₁Te₅, Sn₄Bi₁Te₅

Ge₂Sb₂Te₅:Pb₂Bi₂Te₅

Ge₁Sb₂Te₄:Ge₁Bi₂Te₄, Pb₁Bi₂Te₄, Sn₁Bi₂Te₄, Sn₁Sb₂Te₄

Ge₁Sb₄Te₇:Ge₁Bi₄Te₇, Pb₁Bi₄Te₇, Sn₁Bi₄Te₇

According to the present invention, the atomic ratio of A, B and C (a, b, c) and the ABC alloy fraction (x) may be adjusted so that the solid solution of ABC and GeSbTe alloys can form a single crystalline phase, or a multiphase having a predominant crystalline phase, preferably equal to or more than 90% in volume.

The present invention is further described and illustrated in Examples, which are, however, not intended to limit the scope of the present invention.

### EXAMPLE 1

A thin layer having a composition of (Sn₁Bi₂Te₄)_{0.15}(Ge₁Sb₂Te₄)_{0.85} was formed by sputtering on a glass substrate by applying controlled powers on Ge₁Sb₂Te₄ alloy (Mitsubishi Materials Co., Japan) and Sn₁Bi₂Te₄ alloy (Research & PVD Co., USA) sputter targets.

### COMPARATIVE EXAMPLE 1

The procedure of Example 1 was repeated except that the composition of the thin layer was Ge₁Sb₂Te₄.

Crystal Structure

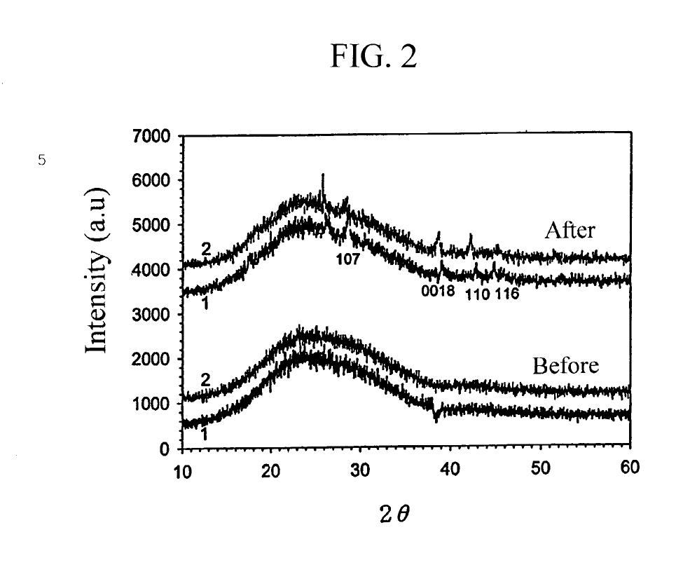

The thin layers of Example 1 and Comparative Example 1 were thermally treated by Rapid Thermal Annealing (RTA) process for 5 min at 300° C. X-ray diffraction patterns of the layers before and after the thermal treatment are shown in FIG. 2, wherein curve 1 represents Comparison Example 1 and curve 2, Example 1 . FIG. 2 demonstrates that both of the thin layers of Example 1 and Comparative Example 1 were amorphous before annealing, and, then, became crystalline after annealing. Further, based on the X-ray diffraction of a known stable Ge₁Sb₂Te₄ crystal, it can be shown that both of the annealed thin layers of Example 1 and Comparison Example 1 are of a hexagonal crystalline structure. In addition, in view of the fact that the 2θ value for the peak having the same lattice plane index is smaller with the layer of Example 1 as compared with that of Comparative Example 1, the lattice constant increases when Sn₁Bi₂Te₄ is dissolved in Ge₁Sb₂Te₄.

Melting Temperature

The melting temperatures of the layers of Example 1 and Comparison Example 1 were determined, using a differential scanning calorimeter at a rate of 10° C./min, to be 606° C. and 614° C., respectively.

Based on the above results and also on the fact that Ge₁Sb₂Te₄ and Sn₁Bi₂Te₄ alloys are of the same crystal structure (lattice constant differences of equivalent crystalline phases are not greater than 5%, i.e., a=0.421 nm and c=4.06 nm in Ge₁Sb₂Te₄, and a=0.4411 nm and c=4.1511 nm in Sn₁Bi₂Te₄; and the melting temperatures thereof are similar, i.e., 615° C. for Ge₁Sb₂Te₄ and 596° C. for Sn₁Bi₂Te₄ ), it can be realized that the Ge₁Sb₂Te₄ and Sn₁Bi₂Te₄ alloys would form a single phase solid solution having uniform physical properties over a wide range.

### EXAMPLE 2

On a 1.2 mm thick polycarbonate disk substrate having a track pitch of 0.6 μm, a first ZnS—SiO₂ (8:2) dielectric layer having the thickness of 270 nm was formed using an RF sputtering method. Then, a recording layer having a composition of (Sn₁Bi₂Te₄)_{0.15}(Ge₁Sb₂Te₄)_{0.85} was formed thereon to the thickness of 20 nm. Subsequently, a second ZnS—SiO₂ (8:2) dielectric layer having the thickness of 20 nm and an Al—Cr reflection layer having the thickness of 100 mn were sequentially formed thereon by RF sputtering, to obtain a 4-layered phase-change type optical recording disc.

### COMPARATIVE EXAMPLE 2

The procedure of Example 2 was repeated except that the composition of the recording layer was Ge₁Sb₂Te₄.

Reflectivity

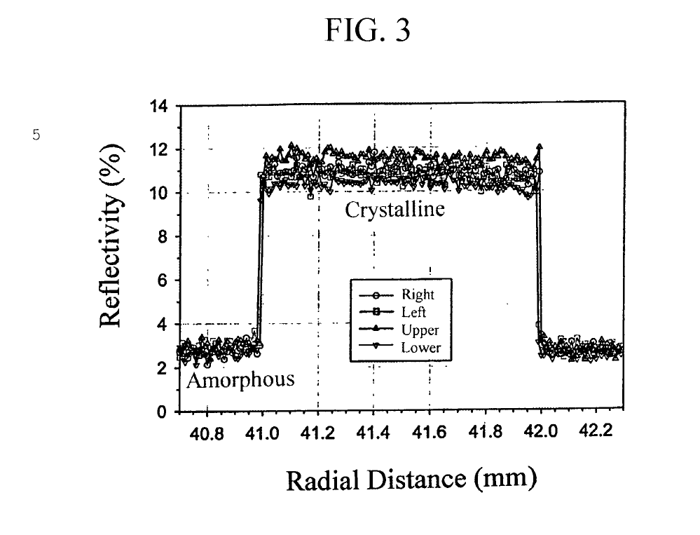

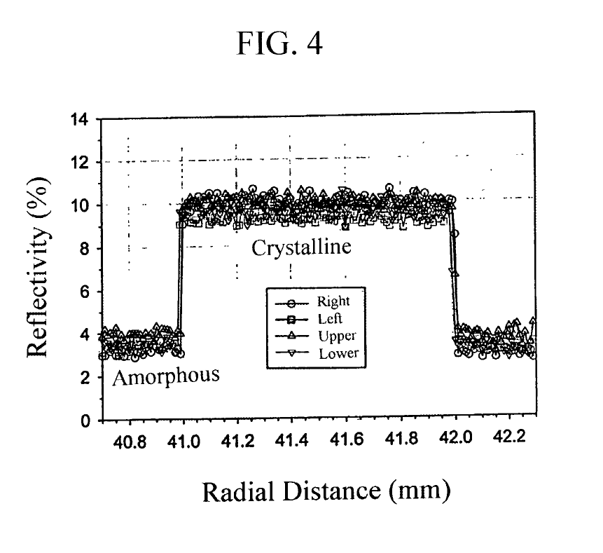

The reflectivity with respect to the radial position of the optical recording discs of Comparative Example 2 and Example 2, was measured with a static/dynamic property evaluating equipment equipped with a 650 nm LD and a 0.6 NA objective lens, and the results are shown in FIGS. 3 and 4, respectively. The reflectivity was measured within a specific range of radius along four different directions, i.e., right, left, upper and lower.

In FIG. 3 or 4, the central portion showing high reflectivity corresponds to a region subjected to crystallization by thermal treatment, and the peripheral portions showing low reflectivity correspond to regions remaining amorphous. The reflectivities of the amorphous state (Rₐ) and the crystalline state (Rₓ) are about 3% and 11%, respectively, for the disc of Comparative Example 2, and about 3.5% and 10%, respectively, for the disc of Example 2. Thus, the optical constants of the amorphous and crystalline phases of the recording layers of Example 2 and Comparative Example 2 are similar to each other.

Recording Properties

Recording properties of the discs prepared in Example 2 and Comparative Example 2 were evaluated. Each of the optical discs was set in an optical disk drive provided with a 650 nm semiconductor laser and a 0.6 NA objective lens. Recording and reproducing was performed under the conditions of 9 m/s linear disc velocity and 23.3 ns timing window (Tw) by way of varying the recording power using a 3Tw recording power and a 7Tw reproducing power. The carrier to noise ratio (CNR) at 4.29 MHz bandwidth corresponding to a reproducing power of 10Tw was measured.

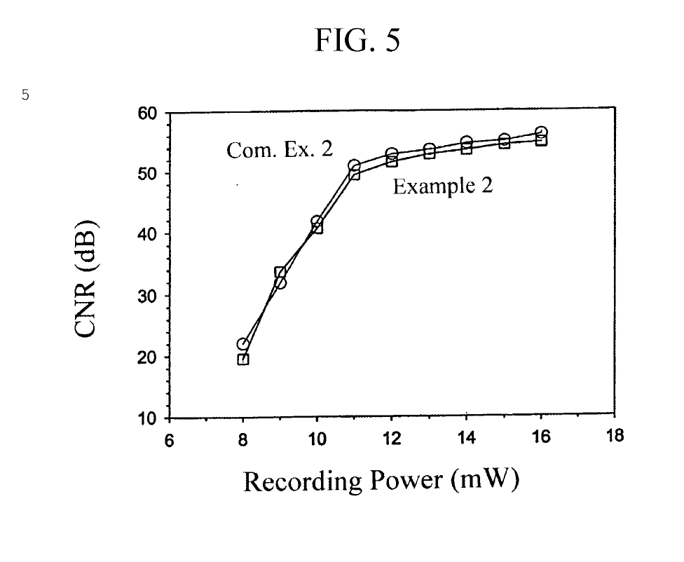

FIG. 5 shows the observed relationship between the recording power and carrier-to-noise ratio (CNR). As can be seen in FIG. 5, the CNR values of the discs of Example 2 and Comparative Example 2 are the same within 1 to 2 dB. This result is believed to be due to the fact that the recording mark sizes of the two discs are similar to each other, judging from the similar amorphous to crystalline contrast ratios, (Rₓ−Rₐ)/(Rₓ+Rₐ), of 0.57 and 0.48 observed for Ge₁Sb₂Te₄ and (Sn₁Bi₂Te₄)_{0.15}(Ge₁Sb₂Te₄)_{0.85}, respectively.

In addition, it can be reasonably predicted that thermophysical constants such as specific heat and thermal conductivity of the materials of Example 1 and Comparative Example 1 would be similar in view of their similar optical constants and melting temperatures.

Erasing Properties

The discs prepared in Example 2 and Comparative Example 2 were recorded under the above-mentioned conditions except that the recording power was adjusted to 15 mW and the linear disc velocity was varied from 3 to 15 m/s. The reduction in CNR was measured after DC erasing using an erasing power of 2 to 10 mW which was varied depending on the linear velocity, and, then, the maximum erasability was determined.

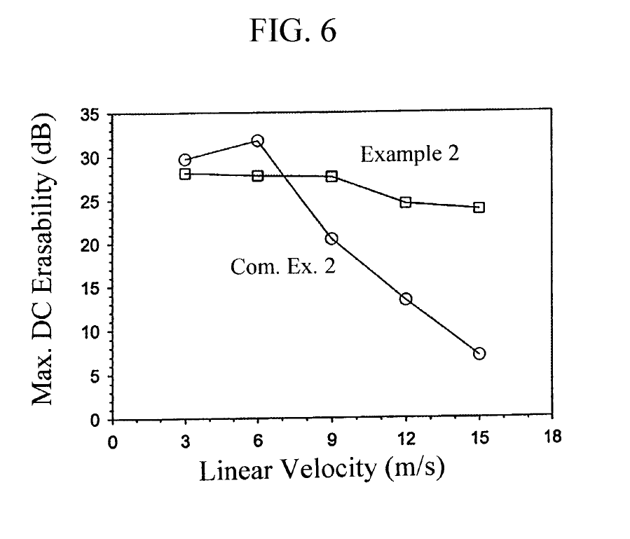

FIG. 6 shows the observed relationship between the linear velocity and maximum DC erasability. As can be seen in FIG. 6, the disc of Comparative Example 2 shows a rapid decline in the erasability when the linear velocity is higher than 6 m/s, the erasability being less than 20 dB at a linear velocity of 9 m/s or higher. In contrast, the inventive disc of Example 2 exhibits far superior erasability at a high linear velocity, for example, as high as 25 dB at a linear velocity of 15 m/s.

As can be seen from the above results, the inventive optical recording material has superior erasability in addition to the good recording properties and high crystallization rate. Therefore, the optical recording material of the present invention may be advantageously applied to a rewritable phase-change type optical recording medium which requires high density recording and transforming speed.

What is claimed is:

1. An optical recording material comprising a composition having the formula of:
(AₐB_{b}C_{c})ₓ(GeₐSb_{b}Te_{c})₁₋ₓ
wherein, A is an element selected from the elements belonging to the IV group in the periodic table; B is an element selected from the elements belonging to the V group in the periodic table; C is an element selected from the elements belonging to the VI group in the periodic table; a, b and c are atomic ratios; x is a fraction in the range of 0 to 1; and the elemental binding energy of at least one of A, B and C is lower than that of the corresponding element in the GeSbTe part.

2. The optical recording material of claim 1, wherein the ABC alloy is selected from the group consisting of (Sn, Bi, Te), (Pb, Bi, Te), (Pb, Bi, Te), (Ge, Bi, Te) and (Sn, Sb, Te).

3. The optical recording material of claim 1, the atomic ratio (a, b, c) is selected from the group consisting of (4, 1, 5), (2, 2, 5), (1, 2, 4) and (1, 4, 7).
